(19) United States
(12) Patent Application Publication
(10) Pub. No.: US 2026/0066846 A1
(43) Pub. Date: Mar. 5, 2026

(54) VEHICLE, COOLING METHOD, AND STORAGE MEDIUM

(71) Applicant: TOYOTA JIDOSHA KABUSHIKI KAISHA, Toyota-shi (JP)

(72) Inventor: Masaru TAKAGI, Toyota-shi (JP)

(73) Assignee: TOYOTA JIDOSHA KABUSHIKI KAISHA, Toyota-shi (JP)

(21) Appl. No.: 19/206,413

(22) Filed: May 13, 2025

(30) Foreign Application Priority Data
Aug. 27, 2024 (JP) 2024-145574

(51) Int. Cl. H02S 40/42; B60R 16/03; H02S 20/30

(52) U.S. Cl. CPC H02S 40/42; B60R 16/03; H02S 20/30

(57) ABSTRACT

A vehicle includes a solar panel that is provided on a top portion of a vehicle body, and a protruding portion that is provided forward of the solar panel on the vehicle body. The protruding portion has a shape that is tapered forward in a front-rear direction of the vehicle body.

### CROSS-REFERENCE TO RELATED APPLICATION

This application claims priority to Japanese Patent Application No. 2024-145574 filed on Aug. 27, 2024. The disclosure of the above-identified application, including the specification, drawings, and claims, is incorporated by reference herein in its entirety.

### BACKGROUND

### 1. Technical Field

The present disclosure relates to a vehicle, a cooling method, and a storage medium.

### 2. Description of Related Art

Japanese Unexamined Patent Application Publication No. 2016-003603 (JP 2016-003603 A) discloses a technique to cool a solar panel by circulating a coolant through a lower face of the solar panel in a vehicle equipped with the solar panel.

### SUMMARY

However, in the vehicle described in JP 2016-003603 A, it is necessary to install a cooling pipe, and the structure of the vehicle thus tends to become complicated. Thus, it is desirable to develop a technique to cool a solar panel with a simple structure in a vehicle equipped with the solar panel.

The present disclosure has been made in view of the above circumstances and provides a vehicle, a cooling method, and a storage medium that can cool a mounted solar panel with a simple structure.

A vehicle according to the present disclosure includes a solar panel provided on a top portion of a vehicle body, and a protruding portion provided forward of the solar panel on the vehicle body. The protruding portion has a shape tapered forward in a front-rear direction of the vehicle body.

A cooling method according to the present disclosure is executed by a vehicle. The vehicle includes a solar panel provided on a top portion of a vehicle body, a protruding portion provided forward of the solar panel on the vehicle body and having a shape tapered forward in a front-rear direction of the vehicle body, and a moving mechanism configured to move the protruding portion. The cooling method includes cooling the solar panel by positioning the protruding portion onto the top portion of the vehicle body using the moving mechanism when the solar panel is generating electric power and the temperature of the solar panel is equal to or higher than a predetermined temperature.

A storage medium according to the present disclosure stores a program that causes a control computer in a vehicle to execute a process. The vehicle includes a solar panel provided on a top portion of a vehicle body, a protruding portion provided forward of the solar panel on the vehicle body and having a shape tapered forward in a front-rear direction of the vehicle body, a moving mechanism configured to move the protruding portion, and the control computer. The process includes cooling the solar panel by positioning the protruding portion onto the top portion of the vehicle body using the moving mechanism when the solar panel is generating electric power and the temperature of the solar panel is equal to or higher than a predetermined temperature.

The present disclosure can provide the vehicle, the cooling method, and the storage medium that can cool the mounted solar panel with a simple structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic top view showing a configuration example of a vehicle according to a first embodiment;

FIG. 2 is a schematic sectional view showing an example of sectional shapes of a solar panel and a protruding portion in the vehicle of FIG. 1;

FIG. 3 is a schematic diagram showing a protruding portion shape list including examples of various shapes of the protruding portion that can be attached to the vehicle of FIG. 1;

FIG. 4 is a block diagram showing a configuration example of a charging device mounted on a vehicle according to a second embodiment;

FIG. 5 is a flowchart for describing an example of a protruding portion moving process in the charging device of FIG. 4; and

FIG. 6 is a diagram showing an example of a hardware configuration of a device.

### DETAILED DESCRIPTION OF EMBODIMENTS

Hereinbelow, the present disclosure will be described through embodiments. However, the disclosure according to the claims is not limited to the following embodiments. In addition, not all of the configurations described in the embodiments are necessarily essential as means for solving the problems.

### First Embodiment

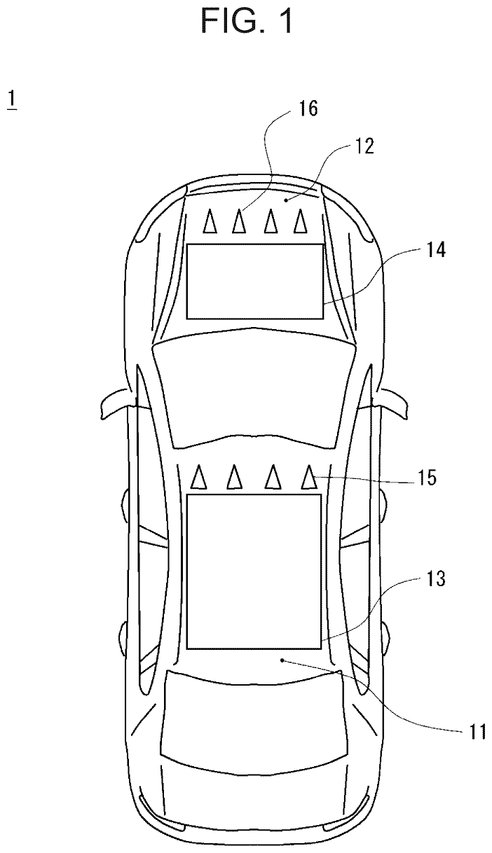

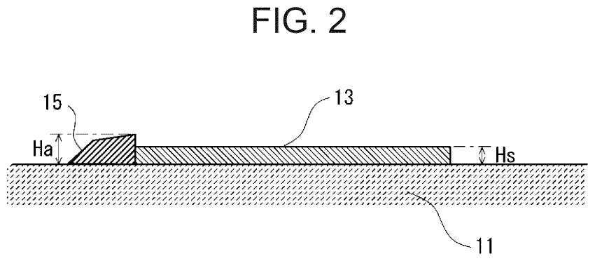

An example of a vehicle according to a first embodiment will be described with reference to FIGS. 1 and 2. FIG. 1 is a schematic top view showing a configuration example of the vehicle according to the first embodiment. FIG. 2 is a schematic sectional view showing an example of sectional shapes of a solar panel and a protruding portion in the vehicle of FIG. 1.

As shown in FIG. 1, a vehicle 1 includes solar panels 13, 14 that are provided on a top portion of a vehicle body. The vehicle body may refer to the entire outer shape of the vehicle 1. That is, the top portion of the vehicle body may refer to a top portion of the vehicle 1. The top portion of the vehicle body may also be referred to as a top face of the vehicle body.

The solar panel 13 is a solar panel that is provided on a roof 11 of the vehicle 1. The solar panel 14 is a solar panel that is provided on a hood 12 of the vehicle 1. It is needless to say that the shape of the vehicle 1 including the shapes of the roof 11 and the hood 12 is not limited to any particular shape. In addition, the solar panels 13, 14 may be respectively embedded in the surface of the roof 11 and the surface of the hood 12.

The number of solar panels provided on the top portion of the vehicle body is not limited to two. One of the solar panels 13, 14 may be provided, or three or more solar panels may be provided. For example, the vehicle 1 may be provided with a solar panel that is embedded in glass such as a windshield. The solar panel may be provided on a trunk lid or a back door.

In addition, as shown in FIG. 1, the vehicle 1 includes protruding portions 15 that are provided forward of the solar panel 13 on the vehicle body, and protruding portions 16 that are provided forward of the solar panel 14 on the vehicle body. Each of the protruding portions 15, 16 may also be referred to as a projection or a projecting portion.

FIG. 1 shows an example in which four protruding portions 15 and four protruding portions 16 are provided. However, the number of protruding portions 15 and the number of protruding portion 16 are not limited to four. The number of protruding portions 15 provided for the solar panel 13 and the number of protruding portions 16 provided for the solar panel 14 may differ from each other.

When a solar panel other than the solar panels 13, 14 are provided on the top portion of the vehicle body, a protruding portion similar to the protruding portions 15, 16 may be provided forward of the solar panel corresponding to the solar panel. For example, when the solar panel is embedded in the windshield, the protruding portion provided corresponding to the solar panel may be disposed on the hood at a position near the windshield.

As illustrated in FIG. 1, each of the protruding portions 15, 16 has a shape tapered forward in the front-rear direction of the vehicle body, that is, tapered forward in the front-rear direction of the vehicle 1.

As described above, in the vehicle 1 according to the present embodiment, at least one protruding portion tapered forward in the vehicle front-rear direction exemplified by the protruding portions 15, 16 is disposed forward of the solar panel in the vehicle front-rear direction, the solar panel being provided on the top portion of the vehicle 1. By providing the protruding portion, airflow caused by traveling becomes turbulence. Thus, in the vehicle 1, the solar panels 13, 14 can be efficiently cooled by turbulence generated by the protruding portions 15, 16 when the vehicle 1 is traveling.

A comparative example will be given to describe effects of the present embodiment. In a vehicle according to the comparative example, a cooling pipe or a water pump that circulates a coolant is installed on a back face of a solar panel on, for example, a roof of the vehicle. In the vehicle according to the comparative example, in addition to requiring a complicated structure such as the cooling pipe or the water pump, the cost of the installation of the complicated structure is high. In addition, when the coolant leaks, the coolant may leak into a vehicle cabin. In addition, in the vehicle according to the comparative example, when the water pump is installed, it is necessary to use electric power to operate the water pump, and the electric power generated by the solar panel is lost. In addition, a vehicle basically includes a vehicle body having a flat or streamlined surface to reduce air resistance during traveling. Thus, although airflow flowing through the vehicle body surface can cool the solar panel during traveling also in the vehicle according to the comparative example, the efficiency of cooling the solar panel using the airflow is low because the airflow is a laminar flow.

On the other hand, the vehicle 1 according to the present embodiment does not adopt a complicated structure as in the comparative example, and can solve the problems in the vehicle according to the comparative example and can cool the solar panel with a simple structure.

In this manner, the present embodiment makes it possible to cool the solar panel mounted on the vehicle with a simple structure. In addition, in the vehicle, since the solar panel can be efficiently cooled, it is possible to improve the charging efficiency of the solar panel.

In addition, as illustrated in FIG. 2, the protruding portion 15 may be configured such that the height Ha of the protruding portion 15 is higher than the height Hs of the solar panel 13. Both the height Ha and the height Hs are based on the same reference, such as the surface of the roof 11 or the ground. In addition, the height Hs can be defined as the height of a portion close to the protruding portion 15. However, the height Hs may be defined as the height of the highest portion of the solar panel 13. Similarly, the protruding portion 16 may be configured such that the height of the protruding portion 16 is higher than the height of the solar panel 14.

In this manner, by setting the height of the protruding portion 15 and the height of the protruding portion 16 higher than the height of the solar panel 13 and the height of the solar panel 14, respectively, the turbulence generated by the protruding portions 15, 16 when the vehicle 1 is traveling flows along the solar panels 13, 14. Thus, by adopting such a configuration, the solar panels 13, 14 can be more efficiently cooled in the vehicle 1.

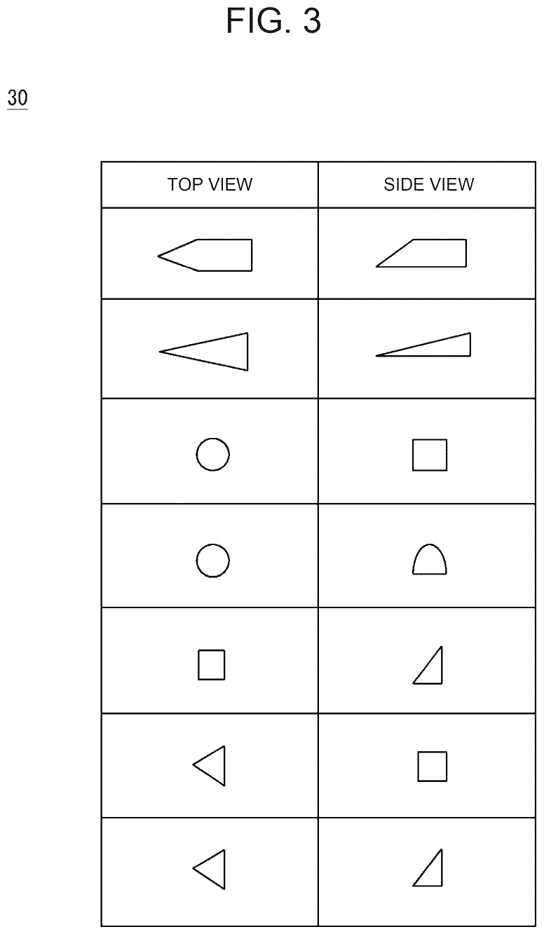

Next, various examples of the shape of the protruding portions 15, 16 will be described with reference to FIG. 3. FIG. 3 is a schematic diagram showing a protruding portion shape list including examples of various shapes of the protruding portion that can be attached to the vehicle 1 in FIG. 1. In the protruding portion shape list 30 shown in FIG. 3, various shapes of the protruding portion in top view and side view are shown, with the left side of the drawing defined as the front side of the vehicle and the right side of the drawing defined as the rear side of the vehicle. In the protruding portion shape list 30, for each protruding portion, the shape in top view and the shape in side view are illustrated as a set.

As illustrated in the protruding portion shape list 30, it is sufficient that the protruding portions 15, 16 are tapered forward in the vehicle front-rear direction at least in the shape in top view or side view. In addition, as shown in an example in which the shape is a circular shape in top view, the protruding portions 15, 16 may also be tapered rearward in the vehicle front-rear direction from a central portion, as long as the protruding portions 15, 16 are tapered forward in the vehicle front-rear direction.

### Second Embodiment

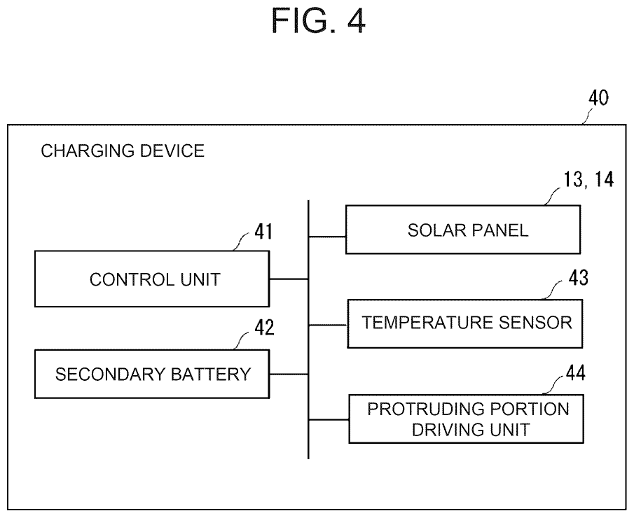

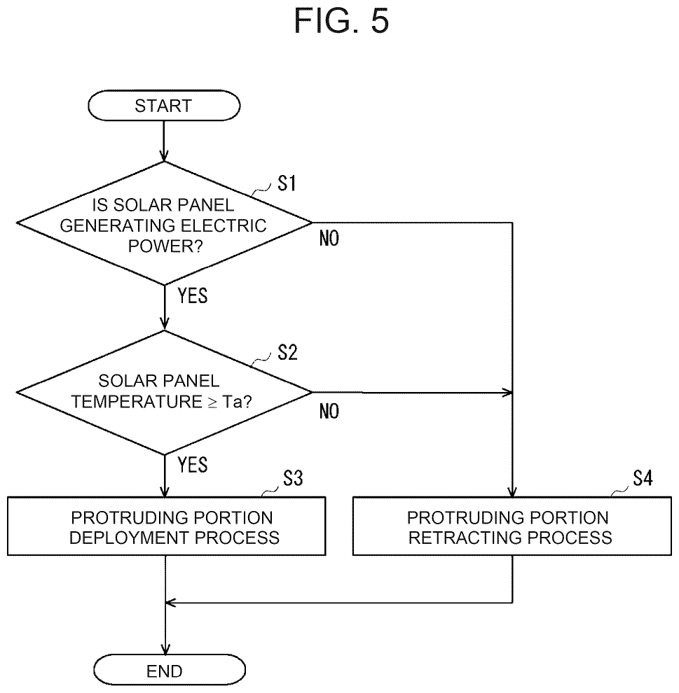

A second embodiment, mainly differences from the first embodiment, will be described with reference to FIGS. 4 and 5. However, various examples described in the first embodiment can be applied in the same manner. FIG. 4 is a block diagram showing a configuration example of a charging device mounted on a vehicle according to the second embodiment. FIG. 5 is a flowchart for describing an example of a protruding portion moving process in the charging device of FIG. 4.

The vehicle 1 shown in FIG. 1 may include a charging device 40 shown in FIG. 4. The charging device 40 may include a control unit 41 that controls the entire charging device 40, a secondary battery 42, the solar panels 13, 14, a temperature sensor 43, and a protruding portion driving unit 44.

The control unit 41 may be implemented, for example, by a computer including a processor such as a central processing unit (CPU), a working memory, and a nonvolatile storage device. A control program to be executed by the processor is stored in the storage device, and the processor reads the control program into the working memory and executes the control program, thereby serving the function of the control unit 41. It is needless to say that the control unit 41 may be configured as a dedicated control circuit such as an electronic control unit (ECU) for charging. In addition, the control unit 41 may be connected to a main control unit such as an ECU mounted to control the entire vehicle 1 or may be provided in the main control unit.

The secondary battery 42 is a battery that stores electric power generated by the solar panels 13, 14. The secondary battery 42 may also be referred to as a battery or an electric power storage device. The secondary battery 42 is connected to a load such as a circuit or a motor (not shown) and can supply electric power to the load.

The temperature sensor 43 is a sensor that measures the temperature of each of the solar panels 13, 14 and may be built in each of the solar panels 13, 14.

The protruding portion driving unit 44 is an example of a moving mechanism that moves each of the protruding portions 15, 16. For example, the protruding portion driving unit 44 may include a motor that moves each of the protruding portions 15, 16. The moving mechanism exemplified by the protruding portion driving unit 44 may be built in the protruding portions 15, 16.

The control unit 41 executes control to cause the protruding portion driving unit 44 to position the protruding portions 15 onto the top portion of the vehicle body when the solar panel 13 is generating electric power and the temperature of the solar panel 13 is equal to or higher than a predetermined temperature. Similarly, the control unit 41 executes control to cause the protruding portion driving unit 44 to position the protruding portions 16 onto the top portion of the vehicle body when the solar panel 14 is generating electric power and the temperature of the solar panel 14 is equal to or higher than a predetermined temperature. The predetermined temperatures to be thresholds for the temperatures of the solar panels 13, 14 may be the same value or different values.

For such control, the control unit 41 may manage information on whether the solar panels 13, 14 are generating electric power and also acquire the temperatures of the solar panels 13, 14 from the temperature sensor 43 at the appropriate time.

In addition, in order to control the positioning of the protruding portions 15, 16 onto the top portion of the vehicle body, the protruding portion driving unit 44 may include a lifting mechanism that raises and lowers each of the protruding portions 15, 16 to and from the top portion of the vehicle body, and a motor that provides power to the lifting mechanism. However, the configuration of the protruding portion driving unit 44 is not limited to this example. For example, when each of the protruding portions 15, 16 is a contractible component that expands and contracts when gas is injected thereinto or suctioned therefrom, the protruding portion driving unit 44 may include a mechanism that causes each of the protruding portions 15, 16 to expand and contract, and a gas injector that provides power to the mechanism.

Next, an example of the protruding portion moving process will be described with reference to FIG. 5.

First, the control unit 41 determines whether the solar panel 13 is generating electric power (step S1). In the case of YES in step S1, the control unit 41 compares a temperature detected by the temperature sensor 43 with a predetermined temperature Ta, and determines whether the detected temperature is equal to or higher than the predetermined temperature Ta (step S2).

In the case of YES in step S2, the control unit 41 controls the protruding portion driving unit 44 to execute a protruding portion deployment process that deploys the protruding portions 15 that are to be projections from the vehicle body (step S3), and then finishes the process. On the other hand, in the case of NO in Step S2, the control unit 41 controls the protruding portion driving unit 44 to execute a protruding portion retracting process that retracts the protruding portions 15 that have been deployed as projections into the vehicle body (step S4), and then finishes the process.

The above process may also be executed in the same manner for the solar panel 14 and the protruding portions 16 provided corresponding to the solar panel 14, independently of the process for the protruding portions 15.

Alternatively, the process in FIG. 5 may be executed as a common process for the protruding portions 15, 16. In this case, for example, the temperature sensor 43 may be provided on only one of the solar panels 13, 14, or the temperature sensor 43 may be provided on each of the solar panels 13, 14 and the higher one of the temperatures may be used for control in the control unit 41. Accordingly, the process in FIG. 5 can switch between deployment and retraction simultaneously for both the protruding portions 15, 16 provided corresponding to the solar panels 13, 14 in accordance with a determination result in step S2. In this case, in step S1, it may be determined whether at least one of the solar panels 13, 14 is generating electric power or whether both of the solar panels 13, 14 are generating electric power.

The protruding portion moving process described above achieves a method of cooling the solar panel executed by the vehicle 1. In the cooling method, the vehicle 1 cools the solar panel by positioning the protruding portion onto the top portion of the vehicle body using the moving mechanism when the solar panel is generating electric power and the temperature of the solar panel is equal to or higher than the predetermined temperature. Other application examples are as described above. In addition, the control program described above is a program that causes a control computer exemplified by the control unit 41 included in the vehicle 1 to execute the following process. That is, the process is a process that cools the solar panel by positioning the protruding portion onto the top portion of the vehicle body using the moving mechanism when the solar panel is generating electric power and the temperature of the solar panel is equal to or higher than the predetermined temperature.

As described above, in the present embodiment, when solar electric power generation is in operation and the temperature of the solar panel is high, the moving mechanism positions the protruding portion onto the top portion of the vehicle body. Thus, in addition to the effects of the first embodiment, the present embodiment makes it possible to suppress increases in air resistance caused by the protruding portions 15, 16 when the temperature of the solar panel is low. Thus, reduction in fuel efficiency can be suppressed.

### Other Embodiments

The present disclosure is not limited to the embodiments and can be modified as appropriate without departing from the gist of the disclosure. For example, in each of the embodiments, the functions of the vehicle and the charging device have been described. However, the vehicle and the charging device are not limited to the illustrated configuration examples, as long as the functions as the vehicle and the charging device can be implemented, and additional functions may be provided. For example, the vehicle 1 has been described on the assumption that the vehicle 1 is an automobile, such as a hybrid electric vehicle, a gasoline-powered vehicle, or a battery electric vehicle. However, the vehicle of the present disclosure may be another type of vehicle, such as a train or a ship.

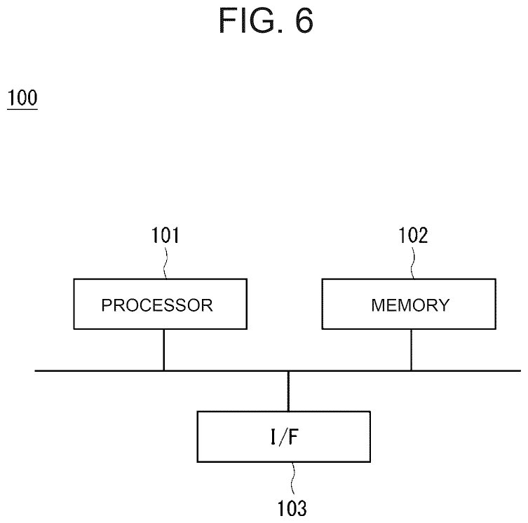

The device such as the charging device built in the vehicle described in each of the embodiments may include the following hardware configuration. FIG. 6 is a diagram showing an example of the hardware configuration of a device.

A device 100 shown in FIG. 6 may include a processor 101, a memory 102, and an interface (I/F) 103. The processor 101 may be, for example, a microprocessor, a microprocessor unit (MPU), or a CPU. The processor 101 may include a plurality of processors. The memory 102 may include, for example, a combination of a volatile memory and a nonvolatile memory. The functions of each device described in each of the embodiments are implemented by the processor 101 reading and executing a program stored in the memory 102. At this time, transmission and reception of information to and from another device can be executed through the I/F 103 serving as a communication interface or an input-output interface.

In addition, the program includes an instruction group (or a software code) for causing the computer to execute one or more of the functions described in the embodiments when read into the computer. The program may be stored on a non-transitory computer readable medium or tangible storage medium. As an example, not a limitation, the computer readable medium or the tangible storage medium includes a random-access memory (RAM), a read-only memory (ROM), a flash memory, a solid-state drive (SSD) or other memory technologies, a CD-ROM, a digital versatile disc (DVD), a Blu-ray (registered trademark) disc, or other optical disc storage, and a magnetic cassette, magnetic tape, magnetic disk storage, or other magnetic storage devices. The program may be transmitted on a transitory computer readable medium or communication medium. As an example, not a limitation, the transitory computer readable medium or the communication medium includes electrical, optical, acoustic, or other forms of propagation signals.

What is claimed is:

1. A vehicle comprising:
a solar panel provided on a top portion of a vehicle body; and
a protruding portion provided forward of the solar panel on the vehicle body, wherein
the protruding portion has a shape tapered forward in a front-rear direction of the vehicle body.

2. The vehicle according to claim 1, wherein a height of the protruding portion is higher than a height of the solar panel.

3. The vehicle according to claim 1, further comprising a moving mechanism configured to move the protruding portion, wherein the moving mechanism positions the protruding portion onto the top portion of the vehicle body when the solar panel is generating electric power and a temperature of the solar panel is equal to or higher than a predetermined temperature.

4. A cooling method executed by a vehicle, the vehicle including a solar panel provided on a top portion of a vehicle body, a protruding portion provided forward of the solar panel on the vehicle body and having a shape tapered forward in a front-rear direction of the vehicle body, and a moving mechanism configured to move the protruding portion, the cooling method comprising
cooling the solar panel by positioning the protruding portion onto the top portion of the vehicle body using the moving mechanism when the solar panel is generating electric power and a temperature of the solar panel is equal to or higher than a predetermined temperature.

5. A non-transitory storage medium storing a program that causes a control computer in a vehicle to execute a process, the vehicle including a solar panel provided on a top portion of a vehicle body, a protruding portion provided forward of the solar panel on the vehicle body and having a shape tapered forward in a front-rear direction of the vehicle body, a moving mechanism configured to move the protruding portion, and the control computer, the process comprising
cooling the solar panel by positioning the protruding portion onto the top portion of the vehicle body using the moving mechanism when the solar panel is generating electric power and a temperature of the solar panel is equal to or higher than a predetermined temperature.
